(19) United States
(12) Patent Application Publication
(10) Pub. No.: US 2024/0413547 A1
(43) Pub. Date: Dec. 12, 2024

(54) ELECTRICAL CONTACT SLEEVE, RF MODULE, AND METHOD

(71) Applicant: Rohde & Schwarz GmbH & Co. KG, München (DE)

(72) Inventors: Nico RIEDMANN, München (DE); Anna Katharina BURGER, Schonstett (DE)

(21) Appl. No.: 18/331,543

(22) Filed: Jun. 8, 2023

(51) Int. Cl. H01R 9/05; H01R 12/52; H01R 13/03

(52) U.S. Cl. CPC H01R 9/0524; H01R 12/52; H01R 13/03

(57) ABSTRACT

The present disclosure provides an electrical contact sleeve comprising a circumferential electrical conductor configured to couple to an outer conductor of an electrically conducting coaxial element at least along a predetermined section of the circumference of the outer conductor, and at least one electrical contact extending from the circumferential electrical conductor and comprising a contacting surface configured to contact an electrically conductive surface of a carrier substrate. In addition, the present disclosure provides a respective RF module and a respective method.

### TECHNICAL FIELD

The disclosure relates to an electrical contact sleeve, a respective RF module, and a respective method.

### BACKGROUND

Although applicable to any type of RF coupling, the present disclosure will mainly be described in conjunction with coaxial conductors for signals in the multi-GHz frequency range.

In modern electronics applications, the used signal frequencies may range up to multiple tens of GHz, like 50 GHz to 100 GHz, or more.

With these frequency ranges, providing electrical connections between single elements in such RF applications becomes more and more challenging.

Accordingly, there is a need for improving connections of elements in electrical RF systems.

### SUMMARY

The above stated problem is solved by the features of the independent claims. It is understood, that independent claims of a claim category may be formed in analogy to the dependent claims of another claim category.

Accordingly, it is provided:

An electrical contact sleeve, that may be called only contact sleeve, comprising a circumferential electrical conductor configured to couple to an outer conductor of an electrically conducting coaxial element at least along a predetermined section of the circumference of the outer conductor; and at least one electrical contact extending from the circumferential electrical conductor and comprising a contacting surface configured to contact an electrically conductive surface of a carrier substrate.

Further, it is provided:

An RF module comprising at least one electrical contact sleeve, the electrical contact sleeve comprising a circumferential electrical conductor configured to couple to an outer conductor of an electrically conducting coaxial element at least along a predetermined section of the circumference of the outer conductor, and at least one electrical contact extending from the circumferential electrical conductor and comprising a contacting surface configured to contact an electrically conductive surface of a carrier substrate. The RF module further comprises the carrier substrate comprising for each electrical contact sleeve a signal contacting surface, and a ground contacting surface, and an electrically conducting coaxial element for each electrical contact sleeve, the electrically conducting coaxial element comprising an inner conductor, and an outer conductor, wherein the circumferential electrical conductor of the at least one electrical contact sleeve is coupled to the outer conductor of the respective electrically conducting coaxial element, and wherein the at least one electrical contact of the at least one electrical contact sleeve is coupled to the ground contacting surface of the respective carrier substrate.

Further, it is provided:

A method for manufacturing an electrical contact sleeve, the method comprising at least one of punching or lasering the unfolded shape of the electrical contact sleeve out of a metal or metal alloy and bending the punched or lasered unfolded shape into the final circular shape of the electrical contact sleeve, the unfolded shape comprising a wall section and at least one electrical contact section; or injection molding the final circular shape of the electrical contact sleeve comprising a cylindrical wall and at least one electrical contact extending from the cylindrical wall and galvanizing the injection molded final circular shape with a metal or metal alloy.

It is understood, that the method may be used to manufacture the electrical contact sleeve according to any one of the embodiments disclosed in the present disclosure.

The present disclosure is based on the finding that coupling of electrically conducting coaxial elements to respective circuitry in an RF module requires carefully designing the RF module and all its components, especially, with regard to coupling the shielding conductors of the electrically conducting coaxial element to the housing and a carrier substrate carrying further electrical components.

In RF modules, the shielding of a coaxial cable may be coupled to a metal housing of the respective RF module, or to a ground layer or grounding area of a carrier substrate that contains electrical circuitry of the RF module or both. If the shielding is coupled to the carrier substrate in the RF module, the shielding may e.g., be soldered to the carrier substrate. However, soldering the shielding to the carrier substrate impedes easy replacement of defective parts in the RF module.

The present disclosure, therefore, provides the electrical contact sleeve, and an RF module that may use the electrical contact sleeve to couple e.g., a coaxial connector to a carrier substrate that carries further electrical circuitry.

The electrical contact sleeve may be used to contact an outer conductor of the electrically conducting coaxial element and to couple the outer conductor of the electrically conducting coaxial element with a respective carrier substrate in the RF module.

The outer conductor may also be referred to as the shielding or shield of the electrically conducting coaxial element. The electrically conducting coaxial element may e.g., comprise a coaxial connector or a coaxial cable.

For coupling the electrically conducting coaxial element to the electrical contact sleeve comprises the circumferential electrical conductor and the at least one electrical contact.

The outer conductor may comprise an outer or an inner circumference that may be coupled to by the circumferential electrical conductor. The circumferential electrical conductor may, therefore, be seen as a ring-like element that may be put over or on, or that may be put in or into, or that may be clamped to the outer conductor of the electrically conducting coaxial element from the outside or the inside. The circumferential electrical conductor, therefore, electrically couples to the outer conductor at least along a predetermined section of the circumference of the outer conductor.

In embodiments, the predetermined section may range between 50% and 100% of the circumference of the outer conductor, especially with a circular outer conductor. If the circumferential electrical conductor covers more than 50% of the circumference of the outer conductor, the circumferential electrical conductor may not easily slide off the outer conductor. If the circumferential electrical conductor covers 100% of the outer conductor, the circumferential electrical conductor may be press-fitted onto the outer conductor and may be strongly fixed to the outer conductor. If the circumferential electrical conductor covers less 100% of the outer conductor, the circumferential electrical conductor may be designed to generate a clamping force that holds the circumferential electrical conductor on the outer conductor.

In embodiments, the outer conductor may comprise any other shape than a circular shape, especially a rectangular or square shape. In such embodiments, the electrical contact sleeve may be formed accordingly and snap onto or into the rectangular or square shaped outer conductor the same way as with a circular outer conductor.

The at least one electrical contact is coupled to and extends from the circumferential electrical conductor, and may be used to electrically couple the electrical contact sleeve to a carrier substrate in the RF module. To this end, the at least one electrical contact comprises a contacting surface for contacting an electrically conductive surface of the carrier substrate. The electrically conductive surface of the carrier substrate may be a ground or shielding area or layer provided on the carrier substrate.

With the electrical contact sleeve, it is, therefore, possible to easily provide electrical contact to an outer conductor, also called shield or shielding contact, of the conducting coaxial element, and couple the electrically conducting coaxial element to the carrier substrate via the respective contacting surfaces.

In the RF module, the electrically conducting coaxial element may serve to acquire or output RF signals, and the carrier substrate may comprise respective signal acquisition or signal generation circuitry.

In the RF module, in order to provide an electrical contact between the circuitry on the single carrier substrate and the respective electrically conducting coaxial element, a respective electrical contact sleeve is provided for every electrically conducting coaxial element.

The electrical contacts of the respective electrical contact sleeve are electrically coupled to respective ground contacting surfaces of the respective carrier substrate that also carries the electrical circuitry. It is understood, that multiple electrical contacts of a single electrical contact sleeve may be coupled to the same ground contacting surface on a carrier substrate, or to different ground contacting surfaces. A single ground contacting surface may also be coupled to multiple electrical contacts of an electrical contact sleeve or of multiple electrical contact sleeves. Therefore, the electrically conducting coaxial elements may easily be coupled to the respective carrier substrates in the RF module. It is understood, that a single or multiple e.g., two, three or more carrier substrates are possible that may be coupled to different electrical contact sleeve.

Consequently, the single electrical contacts of the electrical contact sleeves are each galvanically coupled to respective ground contacting surfaces of the respective carrier substrates.

Further, the signal or inner conductor of the electrically conducting coaxial element may be provided e.g., as a pin, rod or wire. Such an inner conductor may be electrically or galvanically coupled to the signal contacting surface of the respective carrier substrate e.g., by soldering or fixing with a terminal block or the like.

The electrical contact sleeve may be manufactured using different methods. In an embodiment, the unfolded shape of the electrical contact sleeve may be punched out or laser cut from a sheet metal or metal alloy, and may then be bent accordingly. It is understood, that the electrical contacts of the electrical contact sleeve may also be manufactured separately and may be attached to the circumferential electrical conductor.

In other embodiments, a carrier structure in the shape of the electrical contact sleeve may be manufactured e.g., by injection molding or 3D-printing, and that structure may then be galvanized with a metal or metal alloy layer.

Further embodiments of the present disclosure are subject of the further dependent claims and of the following description, referring to the drawings.

In the following, the dependent claims referring directly or indirectly to claim 1 are described in more detail. For the avoidance of doubt, the features of the dependent claims relating to the electrical contact sleeve can be combined in all variations with each other and the disclosure of the description is not limited to the claim dependencies as specified in the claim set. Further, the features of the other independent claims may be combined with any of the features of the dependent claims relating to the electrical contact sleeve in all variations. Especially, the electrical contact sleeves in the RF module may be provided according to any of the embodiments of the electrical contact sleeve provided herein.

In an embodiment, which can be combined with all other embodiments of the electrical contact sleeve mentioned above or below, the circumferential electrical conductor may comprise a contacting surface with a predetermined width in a direction of longitudinal extension of the outer conductor.

The outer conductor and an inner conductor of the electrically conducting coaxial element usually extend longitudinally in the same direction. The inner conductor may e.g., comprise a straight wire as conducting element. The direction of extension of this wire may be the direction of longitudinal extension of the inner and outer conductor. In embodiments, the outer conductor comprises at least a section that extends in the direction of longitudinal extension, while the outer conductor my comprise a bend or curve after this section. The same applies to the inner conductor.

The electrical contact sleeve may comprise a main direction. The main direction may be defined as the normal to the plane that is defined by any one of the two edges of the circumferential electrical conductor. With the circumferential electrical conductor comprising two parallel edges, the normal will always direct in the same direction. The main direction may further be defined as or be the direction of longitudinal extension of the inner and outer conductors of the electrically conducting coaxial element.

The contacting surface of the circumferential electrical conductor may be seen as a stripe that follows the circumference of the outer conductor and comprises a predetermined width.

This width may vary depending on the specific application of the electrical contact sleeve. In embodiments, the width may comprise e.g., the diameter of the outer conductor, or the diameter of the outer conductor multiplied by a factor between 0.5 and 2, or between 0.25 and 4.

Providing the contacting surface with an adequate width will ensure the proper electrical contacting between the outer conductor and the contacting surface.

In another embodiment, which can be combined with all other embodiments of the electrical contact sleeve mentioned above or below, the circumferential electrical conductor may be preloaded to press-fit to the outer conductor in a receiving space between the outer conductor and an inner conductor of the electrically conducting coaxial element, or on the outside of the outer conductor.

The circumferential electrical conductor may be adapted to the specific implementation of the outer conductor of the electrically conducting coaxial element.

In case that the electrically conducting coaxial element is provided as a connector for mounting in the RF module, the electrically conducting coaxial element may comprise an open space between the inner conductor e.g., a wire or conductive rod, and the outer conductor e.g., a conductive housing of the connector. In such embodiments of the electrically conducting coaxial element, the circumferential electrical conductor may be provided as a mechanically pre-loaded element that may be inserted into the space between the inner conductor and the outer conductor. The circumferential electrical conductor may, therefore, push outwards towards the inner wall of the outer conductor and be press-fitted into that space.

In other embodiments of the electrically conducting coaxial element, the outer conductor may be contacted on the outside. In such embodiments, the circumferential electrical conductor may also be provided as a mechanically pre-loaded element. However, instead of pushing outward, the circumferential electrical conductor will contract and on its inside clamp the outside of the outer conductor.

The electrical contact sleeve may in embodiments only be fixed to the outer conductor of the respective electrically conducting coaxial element by radial force or tension. Consequently, no soldering, welding, or bonding is required.

In a further embodiment, which can be combined with all other embodiments of the electrical contact sleeve mentioned above or below, the at least one electrical contact may protrude from the circumferential electrical conductor in at least one of a direction of longitudinal extension of the outer conductor i.e., the main direction of the electrical contact sleeve, or a radial direction from the outer conductor i.e., orthogonally to the main direction.

The at least one electrical contact of the electrical contact sleeve serves for electrically contacting the electrical contact sleeve with an electrically conductive surface of the carrier substrate, especially, a carrier substrate of an RF module.

By coupling the electrical contact sleeve with the respective surface of the carrier substrate, the outer conductor is electrically coupled to the respective surface via the electrical contact sleeve, when mounted in the RF module.

To this end, the at least one electrical contact may protrude from the circumferential electrical conductor in a direction of longitudinal extension of the outer conductor i.e., the main direction of the sleeve, or a radial direction from the outer conductor, or both i.e., with a respective angle to the direction of longitudinal extension of the outer conductor.

The number of electrical contacts in the electrical contact sleeve may be determined depending on the respective application. In embodiments, one electrical contact may be provided in the electrical contact sleeve, in other embodiments more electrical contacts like two, three, or four electrical contacts may be provided.

With multiple electrical contacts provided in the electrical contact sleeve, the electrical contacts may all be provided on the upper side of the carrier substrate, or the electrical contacts may be provided on two different sides of the carrier substrate.

In another embodiment, which can be combined with all other embodiments of the electrical contact sleeve mentioned above or below, the electrical contact sleeve may comprise two electrical contacts that protrude from the circumferential electrical conductor in a direction of longitudinal extension of the outer conductor on opposing sides of an inner conductor of the electrically conducting coaxial element, and on a plane that comprises the axis of longitudinal extension of the inner conductor.

With two electrical contacts protruding from the circumferential electrical conductor, the two electrical contacts may be arranged in a plane with an inner conductor of the electrically conducting coaxial element, such that the electrical contacts are provided on opposing sides of the inner contact and contact the carrier substrate on the same side. This allows providing shield or ground traces alongside a signal trace on both sides of the signal trace to optimize shielding of the signal trace.

It is understood, that in this embodiment further electrical contacts may be provided. Such further electrical contacts may e.g., couple to the carrier substrate on the side of the carrier substrate that is opposite to the side that is contacted by the inner conductor and the first two electrical contacts.

In a further embodiment, which can be combined with all other embodiments of the electrical contact sleeve mentioned above or below, the circumferential electrical conductor may comprise a cylinder, wherein a cylinder wall of the cylinder may comprise a slot.

Common coaxial connectors may comprise the inner conductor as a wire or rod, and the outer conductor as a conductive part of the housing of the connector. Such a conductive part may at least in the area that faces towards the carrier substrate comprise a circular cross section.

Consequently, forming the circumferential electrical conductor as a cylinder allows easily matching the shape of the circumferential electrical conductor to the shape of the outer conductor of the electrically conducting coaxial element.

The slot allows at least slightly compressing or expanding the circumferential electrical conductor to fit the circumferential electrical conductor onto or into the outer conductor of the electrically conducting coaxial element.

As explained above, with specific connectors as electrically conducting coaxial element, the circumferential electrical conductor may be inserted into a space between the inner conductor and the outer conductor, while electrically contacting only the outer conductor. The space between the inner conductor and the inner circumference of the outer conductor may comprise a circular cross section. A circumferential electrical conductor in the form of a cylinder with a slot may, therefore, easily be fitted into such a space.

Of course, the electrically conducting coaxial element may also comprise an outer conductor that does not provide such a space for fitting the circumferential electrical conductor on the inside. Such outer conductors may e.g., comprise a circular outer circumference. In such embodiments, the circumferential electrical conductor may be fitted onto the outer conductor on the outside of the outer conductor.

In another embodiment, which can be combined with all other embodiments of the electrical contact sleeve mentioned above or below, the slot may be at least one of straight-line shaped, angularly-shaped between the two edges of the cylinder wall, curve-shaped, and sawtooth-shaped.

The slot may have any adequate shape. The slot may e.g., be formed as a straight slot or line in a 90° angle from one edge of the cylinder wall to the other edge of the cylinder wall. The slot may also comprise any other angle than 90° to the cylinder wall.

Other possible shapes comprise curve shapes or sawtooth-shapes for the slot.

In a further embodiment, which can be combined with all other embodiments of the electrical contact sleeve mentioned above or below, the slot may fully extend from one of the two edges of the cylinder wall to the other, or the slot may only partially extend from one of the two edges of the cylinder wall to the other.

In embodiments, the slot may extend fully through the cylinder wall from one edge to the other i.e., fully cutting through the cylinder wall.

In other embodiments, the slot may be shorter than the distance between the edges of the cylinder wall i.e., the length of the cylinder. By leaving a section of the cylinder wall without a slot, that section will be very rigid and will not be compressible. This e.g., allows increasing the fitting or pressing force between the circumferential electrical conductor and the outer conductor of the electrically conducting coaxial element.

In an embodiment, which can be combined with all other embodiments of the electrical contact sleeve mentioned above or below, the electrical contact sleeve may comprise a single element that is manufactured by at least one of punching, laser-cutting, and bending.

The electrical contact sleeve may be manufactured by any one of the above-mentioned manufacturing methods or a combination thereof.

The electrical contact sleeve may e.g., be manufactured by punching out the unfolded shape of the electrical contact sleeve and bending the punched-out part into shape.

In embodiments, the circumferential electrical conductor is formed as a single element by any of the above methods, while the at least one electrical contact is manufactured separately and then attached e.g., welded or soldered, to the circumferential electrical conductor.

In another embodiment, which can be combined with all other embodiments of the electrical contact sleeve mentioned above or below, the electrical contact sleeve may comprise a metal or a metal alloy, or may consists of a metal or a metal alloy.

The electrical contact sleeve or the single elements i.e., the circumferential electrical conductor and the at least one electrical contact, may be full metal or metal alloy solid objects. As alternative, the electrical contact sleeve or the single elements may comprise a metal or metal alloy over any other type of material e.g., plastic or rubber.

In a further embodiment, which can be combined with all other embodiments of the electrical contact sleeve mentioned above or below, the at least one electrical contact of the at least one electrical contact sleeve may be soldered to the ground contacting surface of the respective carrier substrate.

Soldering provides a very sturdy coupling between the electrical contacts and the respective ground contacting surface.

In an embodiment, which can be combined with all other embodiments of the RF module mentioned above or below, the RF module may further comprise a dielectric clamping unit for at least one electrical contact sleeve, the dielectric clamping unit being fixed in the RF module to rest on the at least one electrical contact of the respective electrical contact sleeve, and being configured to clamp, or push the at least one electrical contact of the respective electrical contact sleeve to the respective ground contacting surface.

The dielectric clamping unit may comprise any type of device made of dielectric material that may clamp or push or fix the electrical contacts of the respective electrical contact sleeve to the respective ground contacting surfaces.

Such a dielectric clamping unit may comprise a solid block of solid, or flexible material that may be placed on the carrier substrate with the electrical contacts of the respective electrical contact sleeve between the dielectric clamping unit and the respective ground contacting surfaces.

The dielectric clamping unit may, in embodiments, comprise single spring-loaded elements that each push one of the electrical contacts of the respective electrical contact sleeve to the respective ground contacting surfaces.

In another embodiment, which can be combined with all other embodiments of the RF module mentioned above or below, the dielectric clamping unit may further rest on the inner contact of the respective electrically conducting coaxial element, and may be configured to clamp, or push the inner conductor of the respective electrically conducting coaxial element to the respective signal contacting surface.

The dielectric clamping unit may not only push the electrical contacts of the respective electrical contact sleeve to the respective ground contacting surfaces. The dielectric clamping unit may also push the inner conductor of the respective electrically conducting coaxial element onto the respective signal contacting surface.

Such a dielectric clamping unit provides the required electrical contact between the inner conductor for signal transmission, and the outer conductor of the electrically conducting coaxial element with the respective surfaces of the carrier substrate.

The dielectric clamping unit may comprise a solid block of flexible material that may be placed on the carrier substrate with the inner conductor between the dielectric clamping unit and the respective signal contacting surface. As alternative or in addition, the dielectric clamping unit may comprise a spring-loaded element that pushes the inner conductor of the respective electrical contact sleeve to the respective signal contacting surface.

In a further embodiment, which can be combined with all other embodiments of the RF module mentioned above or below, the RF module may further comprise an interchangeable circuit structure, a housing comprising a lower part with a bottom and with housing walls, and a lid, wherein the interchangeable circuit structure comprises a circuit carrier and at least one integrated circuit, wherein the circuit carrier may comprise a plurality of e.g., at least two, fixating surfaces on a first side, and wherein the lid comprises a fixation means for each one of the fixating surfaces, and wherein in a closed state the lid covers the housing to electromagnetically shield the inner space of the housing, and wherein in the closed state each one of the fixation means is in contact with the respective fixating surface. The interchangeable circuit structure, and especially the circuit carrier may implement or provide the carrier substrate.

In another embodiment, which can be combined with all other embodiments of the RF module mentioned above or below, the interchangeable circuit structure may only be fixed and held in the housing by the fixation means, wherein no further fixation is required.

In another embodiment, which can be combined with all other embodiments of the RF module mentioned above or below, a connection area between the interchangeable circuit structure and the bottom of the housing is free of an adhesive or solder or screw, since with the fixation means this is not required.

In a further embodiment, which can be combined with all other embodiments of the RF module mentioned above or below, the bottom of the housing comprises a recess, wherein the at least one interchangeable circuit structure is arranged in the recess for pre-positioning before the clamping force is applied by the fixation means.

In another embodiment, which can be combined with all other embodiments of the RF module mentioned above or below, one or a plurality i.e., two, or three or more, of guide pins may be provided in the housing, wherein the interchangeable circuit structure, especially the circuit carrier of the at least one interchangeable circuit structure may comprise openings and wherein the housing bottom may comprise respective recesses for holding the pins. The plurality of guide pins is arranged within the recesses in the bottom of the housing and extend through the openings of the circuit carrier, thereby locking a movement of the at least one interchangeable circuit structure in two dimensions.

In the closed state of the housing i.e., with the lid covering the housing, the guide pins may rest against the lid and/or may be inserted into respective openings in the lid.

In another embodiment, which can be combined with all other embodiments of the RF module mentioned above or below, the at least one interchangeable circuit structure may be removed, when the housing lid is removed from the housing, since the fixation means will no longer fix the interchangeable circuit structure.

In another embodiment, which can be combined with all other embodiments of the RF module mentioned above or below, the plurality of the fixating surfaces of the carrier may be arranged in a symmetrical manner so that the distribution of the clamping forces is applied equally over the surface of the interchangeable circuit structure.

In an embodiment, which can be combined with all other embodiments of the RF module mentioned above or below, the plurality of the fixating surfaces may be arranged in edge regions of the carrier.

In another embodiment, which can be combined with all other embodiments of the RF module mentioned above or below, the shape of the plurality of the fixating surfaces may be flat or may comprise at least one indentation. The shape of the fixation means of the lid may correspond to the shape of the plurality of fixating surfaces of the interchangeable circuit structure.

In another embodiment, which can be combined with all other embodiments of the RF module mentioned above or below, the lid may comprise a cover. The cover and the plurality of fixation means may be formed as a single piece or element. As alternative, the plurality of fixation means and the cover are separate pieces, wherein the fixation means are screwed, soldered and/or glued to the cover

In a further embodiment, which can be combined with all other embodiments of the RF module mentioned above or below, the plurality of fixation means may be elastic or elastically deformable. As alternative, at least part of the plurality of fixation means may be elastic or elastically deformable. Consequently, an elastic deformation of the fixation means occurs in the closed state of the RF module, such that the required clamping force is produced.

In another embodiment, which can be combined with all other embodiments of the RF module mentioned above or below, the circuit carrier of the at least one interchangeable circuit structure may comprise at least one power distribution surface. The housing may comprises additional openings, wherein a power supply may be arranged through the additional openings and electrically connected to the power distribution surface. Bonding wires may be provided to electrically connect the power distribution surface to the at least one integrated circuit unit.

In an embodiment, which can be combined with all other embodiments of the RF module mentioned above or below, the RF module may comprise at least one connection port, wherein the connection port may comprise an inner conductor and an outer conductor. Such a connection port may be an electrically conducting coaxial element in the form of a connector. The inner conductor may be directly connected to the carrier of the least one interchangeable circuit structure. The inner conductor may also be connected to an intermediate carrier which may be arranged in an in-exchangeable manner within the receiving room. Bonding wires or a coplanar waveguide, also called (G)CPW, may be provided for electrically connecting the intermediate carrier to the at least one interchangeable circuit structure.

In another embodiment, which can be combined with all other embodiments of the RF module mentioned above or below, the RF module may comprise a plurality of interchangeable circuit structures which may be arranged in the same receiving room and which are connected to each other by bonding wires or a waveguide or (G)CPW structure.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using exemplary embodiments which are specified in the schematic figures of the drawings, in which:

FIG. 1 shows a front view of an embodiment of an electrical contact sleeve according to the present disclosure;

FIG. 2 shows a side view of the embodiment of the electrical contact sleeve of FIG. 1;

FIG. 3 shows a top view of the embodiment of the electrical contact sleeve of FIG. 1;

FIG. 4 shows a front view of another embodiment of an electrical contact sleeve according to the present disclosure;

FIG. 5 shows a side view of the embodiment of the electrical contact sleeve of FIG. 4;

FIG. 6 shows a top view of the embodiment of the electrical contact sleeve of FIG. 4;

FIG. 7 shows a schematic view of another embodiment of an electrical contact sleeve according to the present disclosure;

FIG. 8 shows a schematic view of another embodiment of an electrical contact sleeve according to the present disclosure;

FIG. 9 shows a schematic view of another embodiment of an electrical contact sleeve according to the present disclosure;

FIG. 10 shows a block diagram of an embodiment of an RF module according to the present disclosure;

FIG. 11 shows a schematic diagram of an embodiment of a dielectric clamping unit according to the present disclosure;

FIG. 12 shows a block diagram of another embodiment of an RF module according to the present disclosure; and

FIG. 13 shows a flow diagram of an embodiment of a method according to the present disclosure.

In the figures like reference signs denote like elements unless stated otherwise.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

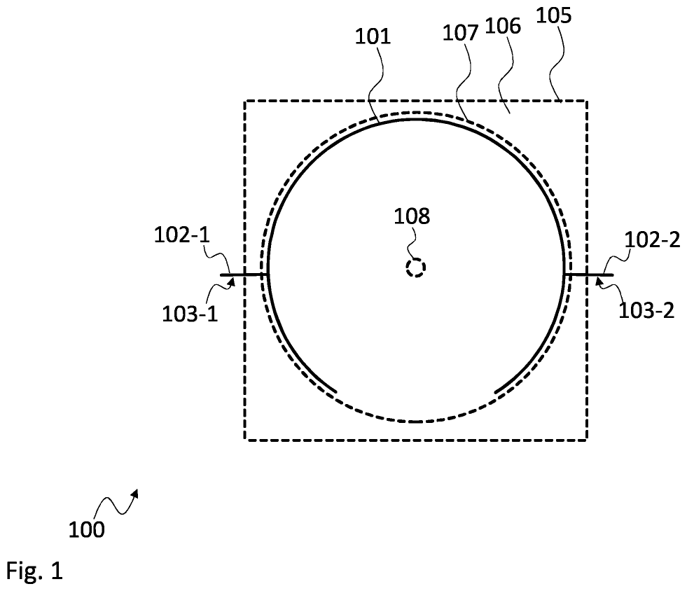

FIG. 1 shows a front view of an electrical contact sleeve 100. The electrical contact sleeve 100 comprises a circumferential electrical conductor 101, and two electrical contacts 102-1, 102-2, which each comprise a contacting surface 103-1, 103-2.

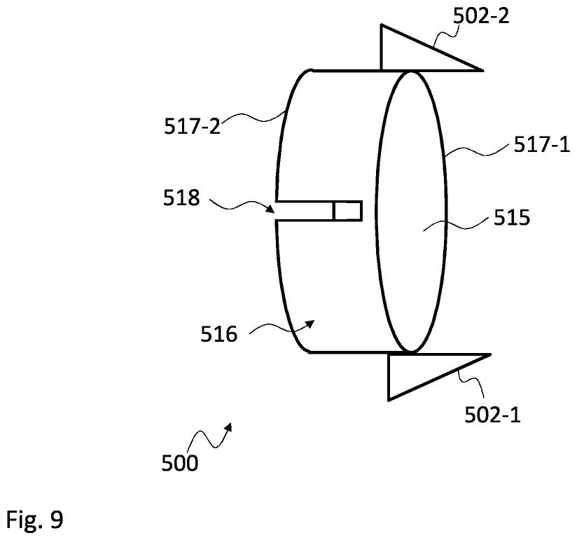

The circumferential electrical conductor 101 is a section of a ring or circularly shaped section of strap or band that covers about 320° and has an opening on the lower side. It is understood, that in other embodiments, the circumferential electrical conductor 101 may cover more or less than 320°, especially a full circle, as may e.g., be seen in FIG. 9.

The circumferential electrical conductor 101 is press fitted into an opening or space in an electrically conducting coaxial element 105 (shown with dashed lines). The opening or space is formed between an inner conductor 108 of the electrically conducting coaxial element 105, and an outer conductor 106 of the electrically conducting coaxial element 105. The circumferential electrical conductor 101 is, therefore, pressed against the inner circumference 107 of the outer conductor 106 or press-fit to the outer conductor 106.

The electrical contact sleeve 100 comprises two electrical contacts 102-1, 102-2 attached to the circumferential electrical conductor 101. The electrical contacts 102-1, 102-2 are attached and electrically coupled to the circumferential electrical conductor 101 such that their lower surfaces i.e., contacting surfaces 103-1, 103-2, are aligned with the lower end of the inner conductor 108.

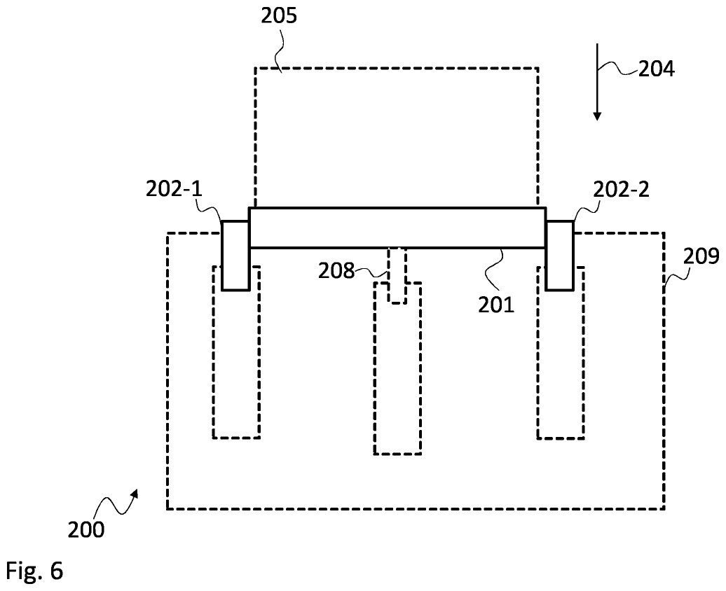

As may be seen e.g., in FIG. 6, this arrangement of the electrical contacts 102-1, 102-2 allows easily attaching the electrical contacts 102-1, 102-2 and the inner conductor 108 to a carrier substrate.

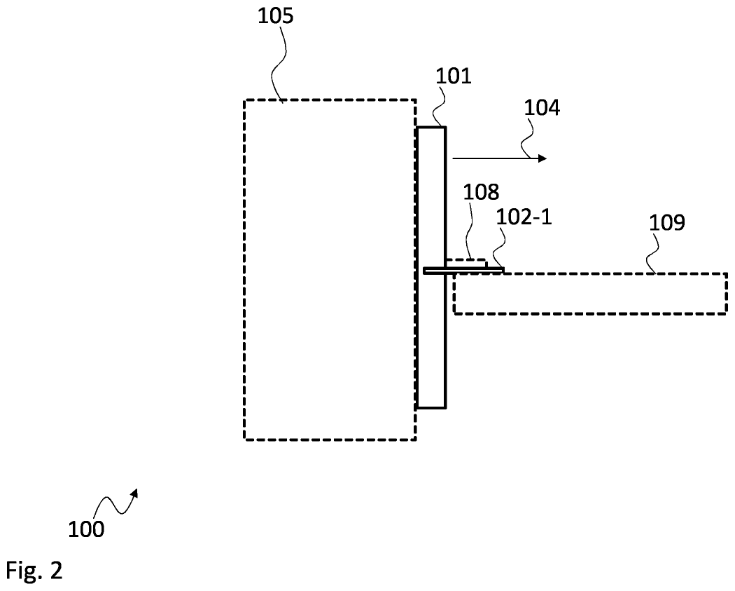

The circumferential electrical conductor 101 may be formed as a ring or section of a ring. The width of that ring or section of a ring may extend along the main axis or direction 104 of the electrical contact sleeve 100, which in FIG. 1 points out of the drawing plane, see FIG. 2.

The electrical contact sleeve 100 may comprise a single element that may be manufactured by at least one of punching, laser-cutting, bending from a metal or a metal alloy.

As alternative, the electrical contact sleeve 100 may comprise a core of another material e.g., a plastic, that is injection molded or formed otherwise, and galvanized with a metal or metal alloy.

FIG. 2 shows a side view of the electrical contact sleeve 100 of FIG. 1. In the side view it can be seen, that the main direction 104 of the electrical contact sleeve 100 is the direction of longitudinal extension of the inner conductor 108, which usually also is the direction of longitudinal extension of the outer conductor 106.

Further, it can be seen that the electrical contacts 102-1, 102-2 may be used to couple the electrical contact sleeve 100 to a carrier substrate 109. It is understood, that the carrier substrate 109 may comprise, but is not limited to, circuit elements, like traces, ICs, filters, resistors, capacitors, and inductances, that may be coupled to the inner conductor 108, and via the electrical contacts 102-1, 102-2 to the outer conductor 106.

Although not explicitly indicated, it is understood, that the electrically conducting coaxial element 105 may comprise e.g., a coaxial connector for attaching a coaxial cable.

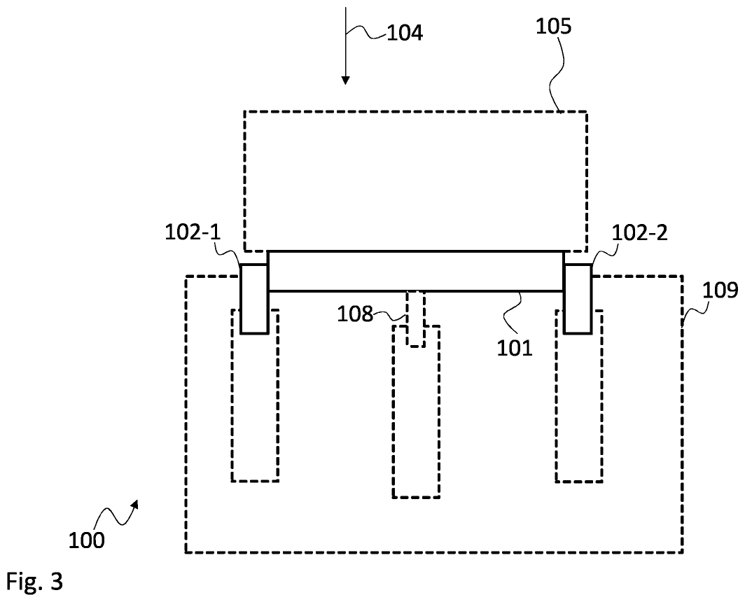

FIG. 3 shows a top view of the electrical contact sleeve 100. In the top view of the electrical contact sleeve 100 it may be seen that both the electrical contacts 102-1, 102-2 may be coupled to individual contacting surfaces of the carrier substrate 109, which may both be ground or shielding surfaces. The inner conductor 108 of the electrically conducting coaxial element 105 may be coupled to another contacting surface of the carrier substrate 109 e.g., to a signal trace.

There exist different forms of establishing electrical or galvanic contact between the electrical contacts 102-1, 102-2 and the contacting surfaces, or the inner conductor 108 and the contacting surface.

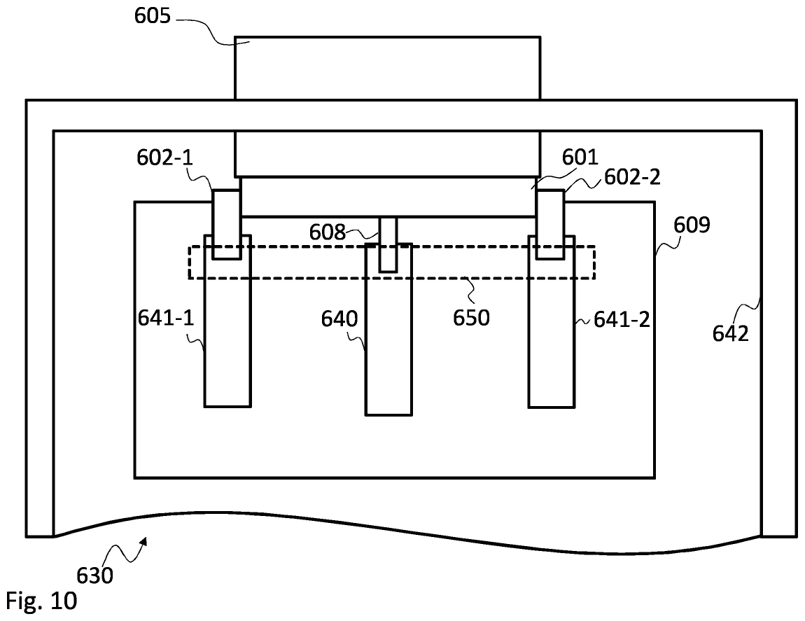

For example, the electrical contacts 102-1, 102-2, or the inner conductor 108 may soldered or spot-welded to the respective contacting surfaces, or the electrical contacts 102-1, 102-2, or the inner conductor 108 may be clamped with respective terminals. Another form of fixing the electrical contacts 102-1, 102-2, or the inner conductor 108 to the respective contacting surface will be exemplified in FIG. 10.

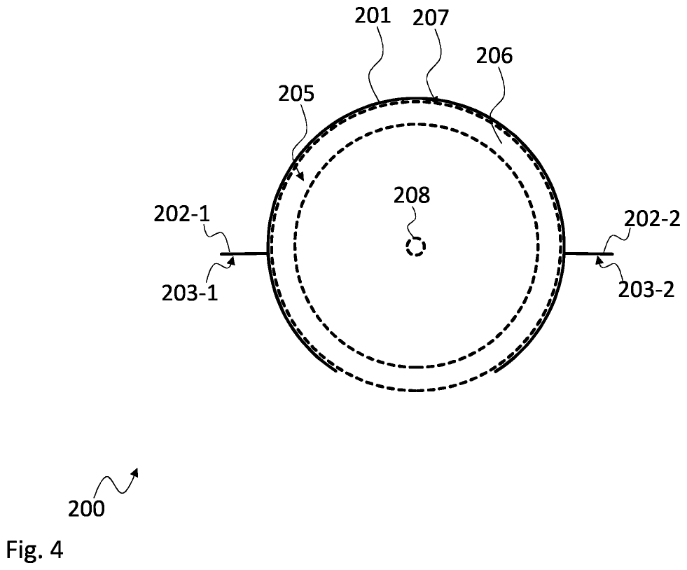

FIG. 4 shows a front view of another electrical contact sleeve 200. The electrical contact sleeve 200 is based on the electrical contact sleeve 100. Therefore, the electrical contact sleeve 200 comprises a circumferential electrical conductor 201, and two electrical contacts 202-1, 202-2 that are attached to the circumferential electrical conductor 201. Each one of the electrical contacts 202-1, 202-2 comprises a lower side that is used as contacting surface 203-1, 203-2. The explanations provided above for the electrical contact sleeve 100, therefore, apply mutatis mutandis to the electrical contact sleeve 200.

In dashed lines an electrically conducting coaxial element 205 is shown. In contrast to the electrical contact sleeve 100, the electrical contact sleeve 200 is fitted to the electrically conducting coaxial element 205 on the outer circumference of the circular outer conductor 206 of the electrically conducting coaxial element 205.

As in FIG. 1, the electrically conducting coaxial element 205 comprises an inner conductor 208, and the contacting surfaces 203-1, 203-2 are aligned with the lower edge of the inner conductor 208.

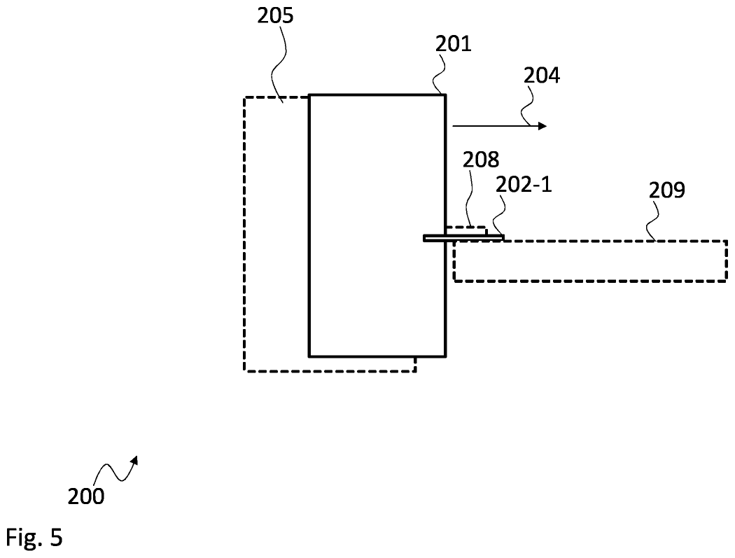

The circumferential electrical conductor 201 may be formed as a ring or section of a ring. The width of that ring or section of a ring may extend along the main axis or direction 204 of the electrical contact sleeve 200, which in FIG. 2 points out of the drawing plane, see FIG. 5.

The electrical contact sleeve 200 may comprise a single element that may be manufactured by at least one of punching, laser-cutting, bending from a metal or a metal alloy.

As alternative, the electrical contact sleeve 200 may comprise a core of another material e.g., a plastic, that is injection molded or formed otherwise, and galvanized with a metal or metal alloy.

FIG. 5 shows a side view of the electrical contact sleeve 200. In the side view it can be seen, that the main direction 204 of the electrical contact sleeve 200 is the direction of longitudinal extension of the inner conductor 208, which usually also is the direction of longitudinal extension of the outer conductor 206. In addition, the electrically conducting coaxial element 205 protrudes on the lower side from the electrical contact sleeve 200, since the electrical contact sleeve 200 is not formed as a full ring, but only as a section of a ring, which is possible in other embodiments.

Further, it can be seen that the electrical contacts 202-1, 202-2 may be used to couple the electrical contact sleeve 200 to a carrier substrate 209. It is understood, that the carrier substrate 209 may comprise, but is not limited to, circuit elements, like traces, ICs, filters, resistors, capacitors, and inductances, that may be coupled to the inner conductor 208, and via the electrical contacts 202-1, 202-2 to the outer conductor 206.

Although not explicitly indicated, it is understood, that the electrically conducting coaxial element 205 may comprise e.g., a coaxial connector for attaching a coaxial cable.

FIG. 6 shows a top view of the electrical contact sleeve 200. In the top view of the electrical contact sleeve 200 it may be seen that both the electrical contacts 202-1, 202-2 may be coupled to individual contacting surfaces of the carrier substrate 209, which may both be ground or shielding surfaces. The inner conductor 208 of the electrically conducting coaxial element 205 may be coupled to another contacting surface of the carrier substrate 209 e.g., to a signal trace.

There exist different forms of establishing electrical or galvanic contact between the electrical contacts 202-1, 202-2 and the contacting surfaces, or the inner conductor 208 and the contacting surface.

For example, the electrical contacts 202-1, 202-2, or the inner conductor 208 may soldered or spot-welded to the respective contacting surfaces, or the electrical contacts 202-1, 202-2, or the inner conductor 208 may be clamped with respective terminals. Another form of fixing the electrical contacts 202-1, 202-2, or the inner conductor 208 to the respective contacting surface will be exemplified in FIG. 10.

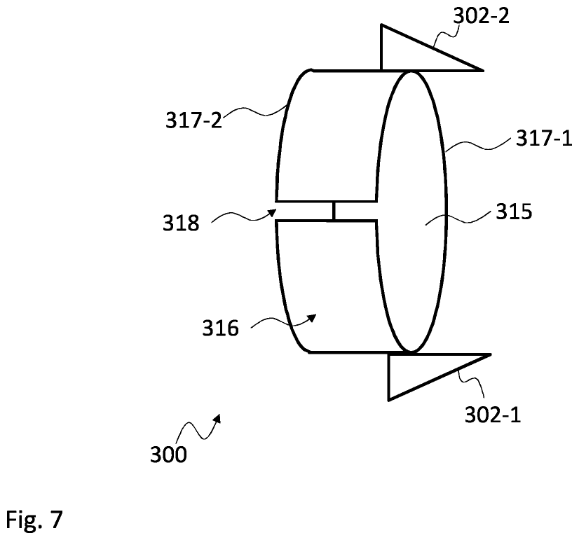

FIG. 7 shows an electrical contact sleeve 300 that may be used with any embodiment of the RF module or the method according to the present disclosure. The electrical contact sleeve 300 comprises a cylinder 315 as circumferential electrical conductor. The cylinder comprises a cylinder wall 316 that is limited by its two edges 317-1, 317-2, wherein the distance between the edges defines the width of the cylinder. The main direction of the electrical contact sleeve 300 may be defined as the direction parallel to the cylinder wall 316 or the cylinder's longitudinal axis.

The cylinder 315 is not provided as full cylinder. Instead, the cylinder 315 comprises a slot 318. The slot 318 of the cylinder 315 is formed as a straight slot comprising a 90° angle to the edges 317-1, 317-2.

The two electrical contacts 302-1, 302-2 in contrast to the electrical contact sleeve 100 and the electrical contact sleeve 200 are not formed as square shaped contacts, but as triangular contacts. It is understood, that in other embodiments, any other shape may be used for the electrical contacts 302-1, 302-2.

Further, the electrical contacts 302-1, 302-2 extend from the cylinder wall 316 mainly in the main direction of the contact sleeve 300 (in FIG. 7 to the right), but may in other embodiments extend to any adequate direction.

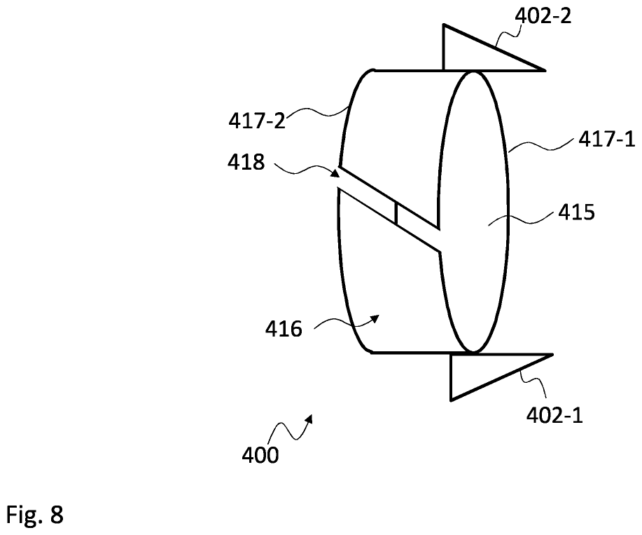

FIG. 8 shows a schematic view of an electrical contact sleeve 400. The electrical contact sleeve 400 is based on the contact sleeve 300. Therefore, the contact sleeve 400 comprises a cylinder 415 as circumferential electrical conductor. The cylinder comprises a cylinder wall 416 that is limited by its two edges 417-1, 417-2, wherein the distance between the edges defines the width of the cylinder. The explanations provided above regarding contact sleeve 300 apply mutatis mutandis to the electrical contact sleeve 400.

The cylinder 415 is not provided as full cylinder. Instead, the cylinder 415 comprises a slot 418. In contrast to the slot 318, the slot 418 of the cylinder 415 is formed as a cut in the cylinder wall 416 that comprises a non-90° angle e.g., a 45° angle, to the edges 417-1, 417-2.

FIG. 9 shows a schematic view of an electrical contact sleeve 500. The electrical contact sleeve 500 is based on the contact sleeve 300. Therefore, the contact sleeve 500 comprises a cylinder 515 as circumferential electrical conductor. The cylinder comprises a cylinder wall 516 that is limited by its two edges 517-1, 517-2, wherein the distance between the edges defines the width of the cylinder. The explanations provided above regarding contact sleeve 300 apply mutatis mutandis to the electrical contact sleeve 500.

The cylinder 515, in contrast to cylinders 315, and 415 is provided as full cylinder i.e., at least part of the cylinder wall 516 is a full cylinder. The cylinder 515 also comprises a slot 518. The slot 518 of the cylinder 515 is formed as a straight slot comprising a 90° angle to the edges 517-1, 517-2. In contrast to the slots 318, the slot 518 of the cylinder 515 does not cut through the full cylinder wall 516, but only reaches partially from the edge 517-2 to the edge 517-1.

FIG. 10 shows a block diagram of an RF module 630. The RF module 630 comprises the electrical contact sleeve 100 as shown in FIGS. 1 to 3 together with an electrically conducting coaxial element 605. The inner conductor 608 of the electrically conducting coaxial element 605 is coupled to a signal contacting surface 640 of a carrier substrate 609. The outer conductor of the electrically conducting coaxial element 605 is coupled via the electrical contacts 602-1, 602-2 and the circumferential electrical conductor 601 to two ground contacting surfaces 641-1, 641-2.

It is understood, that although no further elements are shown on carrier substrate 609, the carrier substrate 609 may be equipped with any required or adequate electrical element that may be coupled to the signal contacting surface 640, and the ground contacting surfaces 641-1, 641-2.

The electrically conducting coaxial element 605, with the electrical contact sleeve, and the carrier substrate 609 are all provided within a housing 642 (closing lid not shown). The housing 642 may comprise a bottom and housing walls, and may be closed by a removable lid. It is understood, that the housing 642 may comprise or consist of a conducting material and may shield the inner components of the RF module 630. The electrically conducting coaxial element 605, as a coaxial connector, may protrude through a respective opening in the housing 642.

In the RF module 630, the electrical contacts 602-1, 602-2, and the inner conductor 608 may be pressed onto or held on the signal contacting surface 640, and the ground contacting surfaces 641-1, 641-2 by a dielectric clamping unit 650 that may be positioned and fixed within the housing 642, such that it pushes or presses down the electrical contacts 602-1, 602-2, and the inner conductor 608.

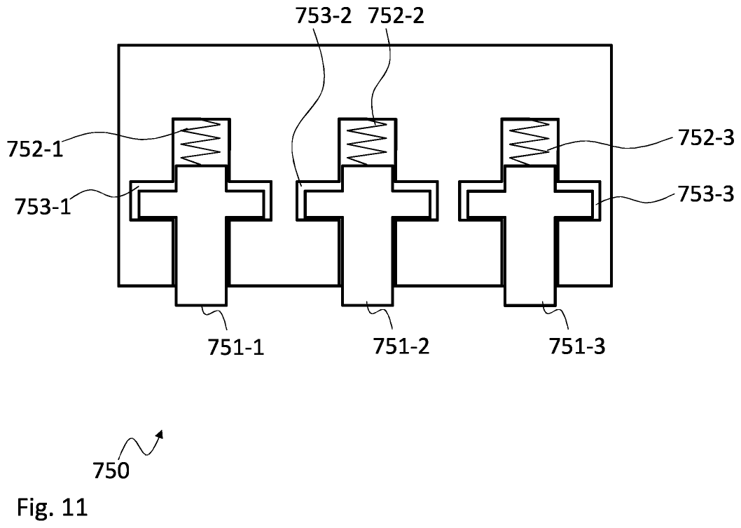

Such a dielectric clamping unit 650 may be provided as a solid block of a dielectric material, which may be a flexible material in embodiments. Another possible embodiment of the dielectric clamping unit is shown in FIG. 11 and explained below.

It is understood, that any of the embodiments provided in this disclosure may be used as electrical contact sleeve in the RF module 630. Further, the RF module 630 may comprise any number of coaxial connectors each with a respective electrical contact sleeve as required in the respective application.

FIG. 11 shows a block diagram of a dielectric clamping unit 750.

The dielectric clamping unit 750 may comprise or fully consist of any dielectric material, like a dielectric plastic material. The shown exemplary dielectric clamping unit 750 serves for holding down three elements. It is understood, that a dielectric clamping unit 750 for less than three e.g., one or two, or more than three, e.g., four, five or more, elements may be provided.

The shown dielectric clamping unit 750 may e.g., be used in the RF module 630, or the RF module 830 to hold down the electrical contacts 602-1, 602-2, 802-1, 802-2, and the inner conductor 608, 808.

The dielectric clamping unit 750 in a body comprises three recesses 753-1, 753-2, 753-3 in the form of a cross, wherein the recesses 753-1, 753-2, 753-3 are open at the bottom or lower edge of the body of the dielectric clamping unit 750. In each one of the recesses 753-1, 753-2, 753-3 a respective stamp 751-1, 751-2, 751-3 is provided, also in the form of a cross, wherein the stamps 751-1, 751-2, 751-3 are dimensioned such that they may move up and down in the recesses 753-1, 753-2, 753-3, the up-down movement being limited by the arms of the stamps 751-1, 751-2, 751-3 touching the walls of the arms of the recesses 753-1, 753-2, 753-3. Each one of the stamps 751-1, 751-2, 751-3 is provided with a spring element or spring 752-1, 752-2, 752-3 that presses the respective stamp 751-1, 751-2, 751-3 down.

When the dielectric clamping unit 750 is positioned in the RF module 630, 830 over the carrier substrate 609, 809, each one of the stamps pushes one of the electrical contacts 602-1, 602-2, 802-1, 802-2 or the inner conductor 608, 808 down onto the carrier substrate 809, thereby ensuring the electrical contact between the electrical contacts 602-1, 602-2, 802-1, 802-2 or the inner conductor 608, 808, and the respective signal contacting surface 640, 840 or ground contacting surface 641-1, 641-2, 841-1, 841-2.

The dielectric clamping unit 750 may be fixed in the housing 642, 842, of the RF module 630, 830 by any adequate means, like screws, clamps, or snap in elements.

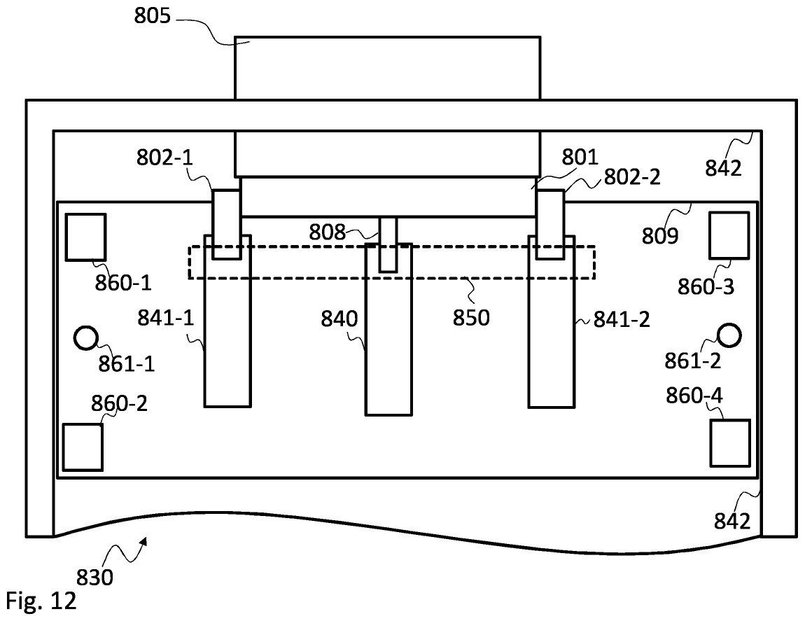

FIG. 12 shows a block diagram of an RF module 830. The RF module 830 is based on the RF module 630. Therefore, the explanations provided above for the RF module 630 apply mutatis mutandis to the RF module 830. The RF module 830 comprises the electrical contact sleeve 100 as shown in FIGS. 1 to 3 together with an electrically conducting coaxial element 805. In embodiments, the RF module 830 or the RF module 630 may also be used with an electrical contact sleeve 200 as shown in FIGS. 4 to 6. The inner conductor 808 of the electrically conducting coaxial element 805 is coupled to a signal contacting surface 840 of a carrier substrate 809. The outer conductor of the electrically conducting coaxial element 805 is coupled via the electrical contacts 802-1. 802-2 and the circumferential electrical conductor 801 to two ground contacting surfaces 841-1, 841-2. It is understood, that although no further elements are shown on carrier substrate 809, the carrier substrate 809 may be equipped with any required or adequate electrical element that may be coupled to the signal contacting surface 840, and the ground contacting surfaces 841-1, 841-2.

The electrically conducting coaxial element 805, with the electrical contact sleeve, and the carrier substrate 809 are all provided within a housing 842 (closing lid not shown). The housing 842 may comprise a bottom and housing walls, and may be closed by a removable lid. It is understood, that the housing 842 may comprise or consist of a conducting material and may shield the inner components of the RF module 830. The electrically conducting coaxial element 805, as a coaxial connector, may protrude through a respective opening in the housing 842.

The carrier substrate 809 comprises four fixating surfaces 860-1, 860-2, 860-3, 860-4. In other embodiments, the number of fixating surfaces 860-1, 860-2, 860-3, 860-4 may be less e.g., one, two, or three, or more e.g., five, six or more.

Further, two rods 861-1, 861-2 are provided in the RF module 830. The rods 861-1, 861-2 protrude from the bottom of the housing 842 through the carrier substrate 809. In the (not shown) lid, respective openings or recesses may be provided to fix the upper ends of the rods 861-1, 861-2 in a closed stated of the lid. In other embodiments, the number of rods 861-1. 861-2 may be less than two e.g., one, or higher than two e.g., three or four or more.

The fixating surfaces 860-1, 860-2, 860-3, 860-4 serve for fixing the carrier substrate 809 in the housing 842 when the lid is closed. To this end, the lid may comprise respective fixation means or fixation elements that in the closed state of the lid rest on the fixating surfaces 860-1. 860-2, 860-3, 860-4 to press down the carrier substrate 809 and hold the carrier substrate 809 in position.

The lid may e.g., comprise respective spring elements, rods, especially elastically deformable rods, or snap in elements that may rest on the fixating surfaces 860-1, 860-2, 860-3. 860-4 to hold the carrier substrate 809 down after closing the lid.

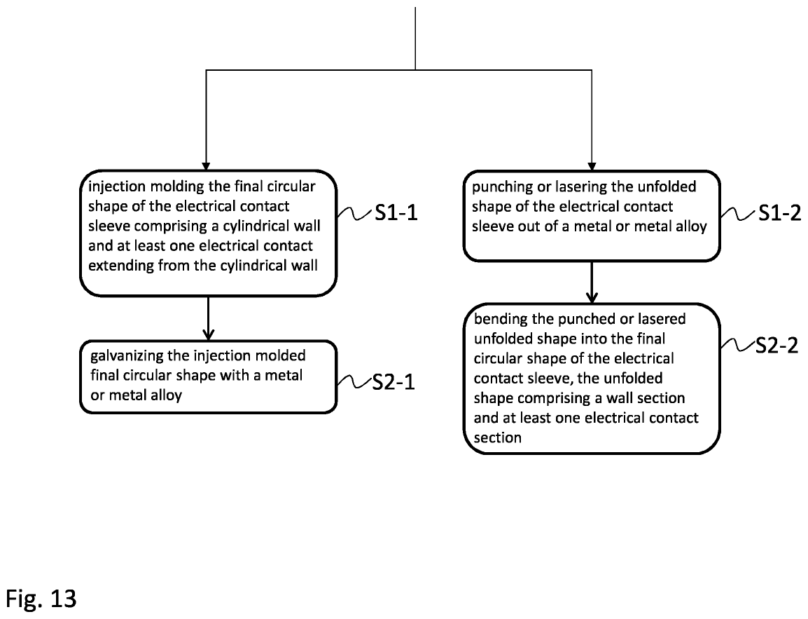

FIG. 13 shows a flow diagram of an embodiment of a method for manufacturing an electrical contact sleeve.

The method comprises punching or lasering S1-2 the unfolded shape of the electrical contact sleeve out of a metal or metal alloy, and bending S2-2 the punched or lasered unfolded shape into the final circular shape of the electrical contact sleeve, the unfolded shape comprising a wall section and at least one electrical contact section. As alternative, the method may comprise injection molding S1-1 the final circular shape of the electrical contact sleeve comprising a cylindrical wall and at least one electrical contact extending from the cylindrical wall, and galvanizing S2-1 the injection molded final circular shape with a metal or metal alloy.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, case of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### LIST OF REFERENCE SIGNS

100, 200, 300, 400, 500 electrical contact sleeve
101, 201, 301, 601, 801 circumferential electrical conductor
102-1, 102-2, 202-1, 202-2, 302-1, 302-2 electrical contact
402-1, 402-2, 502-1, 502-2, 602-1, 602-2 electrical contact
802-1, 802-2 electrical contact
103-1, 103-2, 203-1, 203-2 contacting surface
104, 204 main direction
105, 205, 605, 805 electrically conducting coaxial element
106, 206 outer conductor
107, 207 circumference
108, 208, 608, 808 inner conductor
109, 209, 609, 809 carrier substrate
315, 415, 515 cylinder
316, 416, 516 cylinder wall
317-1, 317-2, 417-1, 417-2, 517-1, 517-2 edge
318, 418, 518 slot
630, 830 RF module
640, 840 signal contacting surface
641-1, 641-2, 841-1, 841-2 ground contacting surface
642, 842 housing
650, 750, 850 dielectric clamping unit
751-1, 751-2, 751-3 stamp
752-1, 752-2, 752-3 spring
753-1, 753-2, 753-3 recess
860-1, 860-2, 860-3, 860-4 fixating surfaces
861-1, 861-2 rod
S1-1, S1-2, S2-1, S2-2 method steps

What is claimed is:

1. An electrical contact sleeve comprising:
a circumferential electrical conductor configured to couple to an outer conductor of an electrically conducting coaxial element at least along a predetermined section of the circumference of the outer conductor; and
at least one electrical contact extending from the circumferential electrical conductor and comprising a contacting surface configured to contact an electrically conductive surface of a carrier substrate.

2. The electrical contact sleeve according to claim 1, wherein the circumferential electrical conductor comprises a contacting surface with a predetermined width in a direction of longitudinal extension of the outer conductor.

3. The electrical contact sleeve according to claim 1, wherein the circumferential electrical conductor is preloaded to press-fit to the outer conductor:
in a receiving space between the outer conductor and an inner conductor of the electrically conducting coaxial element; or
on the outside of the outer conductor.

4. The electrical contact sleeve according to claim 1, wherein the at least one electrical contact protrudes from the circumferential electrical conductor in at least one of a direction of longitudinal extension of the outer conductor, or a radial direction from the outer conductor.

5. The electrical contact sleeve according to claim 1, comprising two electrical contacts that protrude from the circumferential electrical conductor in a direction of longitudinal extension of the outer conductor on opposing sides of an inner conductor of the electrically conducting coaxial element, and on a plane that comprises the axis of longitudinal extension of the inner conductor.

6. The electrical contact sleeve according to claim 1, wherein the circumferential electrical conductor comprises a cylinder, and wherein a cylinder wall of the cylinder comprises a slot.

7. The electrical contact sleeve according to claim 6, wherein the slot is at least one of straight-line shaped, angularly-shaped between the two edges of the cylinder wall, curve-shaped, and sawtooth-shaped.

8. The electrical contact sleeve according to claim 6, wherein the slot fully extends from one of the two edges of the cylinder wall to the other; or wherein the slot partially extends from one of the two edges of the cylinder wall to the other.

9. The electrical contact sleeve according to claim 1, wherein the electrical contact sleeve comprises a single element that is manufactured by at least one of punching, laser-cutting, bending.

10. The electrical contact sleeve according to claim 1, wherein the electrical contact sleeve comprises a metal or a metal alloy; or consists of a metal or a metal alloy.

11. An RF module comprising:
at least one electrical contact sleeve, the electrical contact sleeve comprising:
a circumferential electrical conductor configured to couple to an outer conductor of an electrically conducting coaxial element at least along a predetermined section of the circumference of the outer conductor; and
at least one electrical contact extending from the circumferential electrical conductor and comprising a contacting surface configured to contact an electrically conductive surface of a carrier substrate;
the RF module further comprising:
the carrier substrate comprising for each electrical contact sleeve a signal contacting surface, and a ground contacting surface; and
the electrically conducting coaxial element for each electrical contact sleeve, the electrically conducting coaxial element comprising an inner conductor, and an outer conductor;
wherein the circumferential electrical conductor of the at least one electrical contact sleeve is coupled to the outer conductor of the respective electrically conducting coaxial element; and
wherein the at least one electrical contact of the at least one electrical contact sleeve is coupled to the ground contacting surface of the respective carrier substrate.

12. The RF module according to claim 11, wherein the at least one electrical contact of the at least one electrical contact sleeve is soldered to the ground contacting surface of the respective carrier substrate.

13. The RF module according to claim 11, further comprising:
a dielectric clamping unit for at least one electrical contact sleeve;
the dielectric clamping unit being fixed in the RF module to rest on the at least one electrical contact of the respective electrical contact sleeve, and being configured to clamp the at least one electrical contact of the respective electrical contact sleeve to the respective ground contacting surface.

14. The RF module according to claim 13, wherein the dielectric clamping unit further rests on the inner contact of the respective electrically conducting coaxial element, and is configured to clamp the inner conductor of the respective electrically conducting coaxial element to the respective signal contacting surface.

15. The RF module according to claim 11, wherein the circumferential electrical conductor of at least one electrical contact sleeve comprises a contacting surface with a predetermined width in a direction of longitudinal extension of the outer conductor of the respective electrically conducting coaxial element.

16. The RF module according to claim 11, wherein the circumferential electrical conductor of at least one electrical contact sleeve is preloaded to press-fit to the outer conductor of the respective electrically conducting coaxial element:
in a receiving space between the outer conductor and an inner conductor of the respective electrically conducting coaxial element; or
on the outside of the outer conductor of the respective electrically conducting coaxial element.

17. The RF module according to claim 11, wherein the at least one electrical contact of at least one electrical contact sleeve protrudes from the circumferential electrical conductor in at least one of a direction of longitudinal extension of the outer conductor, or a radial direction from the outer conductor of the respective electrically conducting coaxial element.

18. The RF module according to claim 11, wherein at least one electrical contact sleeve comprises two electrical contacts that protrude from the circumferential electrical conductor in a direction of longitudinal extension of the outer conductor of the respective electrically conducting coaxial element on opposing sides of an inner conductor of the respective electrically conducting coaxial element, and on a plane that comprises the axis of longitudinal extension of the inner conductor of the respective electrically conducting coaxial element.

19. The RF module according to claim 11, wherein the circumferential electrical conductor of at least one electrical contact sleeve comprises a cylinder, and wherein a cylinder wall of the cylinder comprises a slot.

20. The RF module according to claim 19, wherein the slot is at least one of straight-line shaped, angularly-shaped between the two edges of the cylinder wall, curve-shaped, and sawtooth-shaped.

21. The RF module according to claim 19, wherein the slot fully extends from one of the two edges of the cylinder wall to the other; or wherein the slot partially extends from one of the two edges of the cylinder wall to the other.

22. The RF module according to claim 11, wherein at least one electrical contact sleeve comprises a single element that is manufactured by at least one of punching, laser-cutting, bending.

23. The RF module according to claim 11, wherein at least one electrical contact sleeve comprises a metal or a metal alloy; or consists of a metal or a metal alloy.

24. The RF module according to claim 11, further comprising an interchangeable circuit structure, a housing comprising a lower part with a bottom and with housing walls, and a lid;
wherein the interchangeable circuit structure comprises a circuit carrier and at least one integrated circuit, and wherein the circuit carrier comprises a plurality of fixating surfaces on a first side; and
wherein the lid comprises a fixation means for each one of the fixating surfaces, and wherein in a closed state the lid covers the housing to electromagnetically shield the inner space of the housing, and wherein in the closed state each one of the fixation means is in contact with the respective fixating surface.

25. Method for manufacturing an electrical contact sleeve, the method comprising at least one of:
punching or lasering the unfolded shape of the electrical contact sleeve out of a metal or metal alloy and bending the punched or lasered unfolded shape into the final circular shape of the electrical contact sleeve, the unfolded shape comprising a wall section and at least one electrical contact section; or
injection molding the final circular shape of the electrical contact sleeve comprising a cylindrical wall and at least one electrical contact extending from the cylindrical wall and galvanizing the injection molded final circular shape with a metal or metal alloy.
